(19) United States
(12) Patent Application Publication
(10) Pub. No.: US 2012/0233551 A1
(43) Pub. Date: Sep. 13, 2012

(54) System Of Spatial Enterprise Solution

(76) Inventor: Xuewei Ren, Sandy Springs, GA (US)

(21) Appl. No.: 13/045,513

(22) Filed: Mar. 10, 2011

(51) Int. Cl. G06F 3/048; G06F 15/16

(52) U.S. Cl. 715/744; 709/203

(57) ABSTRACT

Disclosed is a system defined, designed and implemented to provide the platform for the spatial solutions of the enterprise business workflows. In this system, the spatial solutions can be configured into the different models, which include the data source model, the virtual data model, the rendering model, the user access model, the customization model and the resource model. The system provides the spatial solutions by integrating these models. Architecturally, the system consists of three major components—the server, the admin console and the clients. The server integrates the different models, processes the data, and passes the processing results to the clients. The admin console configures these models. The clients, which run on the different platforms, render the models in the graphic manner and execute the frontend business logics.

### BACKGROUND OF THE INVENTION

Modern information technologies have been evolving rapidly last decade. The computing devices have been designed for the higher mobility, the faster connection, the smaller size and the richer functionality. More and more users are looking for the solutions that can run on the mobile devices. While the mobile device gives user the convenience and flexibility, it also gives the software developers the challenges. It requires the software programs to be smaller, faster and more intuitive.

Traditionally, the enterprise solutions have been using the tabular data, which means the data are represented in the forms of tables. Tabular data is easy to manage, but not intuitive. For the intuition, the spatial data, which represent the objects in the graphic manner, have the advantages.

The spatial data are the data that are represented by the geometric entities such as line, polygon, rectangle, point, etc. Using the spatial data for the enterprise solutions can make the system more intuitive. The more intuitive is the system, the easier can people use it. Hence, adopting the spatial data in the enterprise system can dramatically improve the acceptance of the enterprise system.

Geospatial Information System (GIS) have been using the spatial data to provide the solutions in the different industries. While GIS can be one of the alternatives for the spatial enterprise solutions, it cannot really solve the problems. First, GIS was invented for the use of the digital maps, not for the enterprise solutions, which are supposed to capture the enterprise business logics. GIS lacks the basic architectural support for the enterprise solutions. Second, GIS systems are using the heavy frontend standalone applications, which are too big to run on the mobile devices. These applications were designed to run only on the desktop computers, not the mobile devices.

The CAD (Computer Aide Design) platform is another graphic platform. It is also capable of capturing some spatial solutions. But, all CAD programs are also just the frontend applications. The lack of the multi-tiered enterprise architecture makes it impossible to isolate an abstract tier to handle the business logics for multiple clients of multi-user system. Plus, all the CAD platforms are also too heavy to run on mobile devices. CAD program is not the choice of the spatial enterprise solutions, either.

Given the challenges on the mobile computing and the complexities of the enterprise solutions, the present invention intends to define, design and implement a new system to solve the problem. Spatial Enterprise System (SES) is invented for such a purpose. It is the completely-redefined system, in which the spatial data are used to solve the enterprise problems. It has the multi-tiered architecture to fit the enterprise solutions so that the business logics can be captured on one dedicated tier.

SES has the virtual data model, upon which the developers can write programs. The virtual data model is independent to the data storage. It can make the solutions to be developed separately from the data storage of the current enterprise systems. Meanwhile, the data structures of the existing systems can be mapped to the virtual data model so that the existing business data can be used for the newly developed solutions.

SES is the spatial data management system, in which the spatial data are indexed automatically. This guarantees the efficiency of the spatial data being retrieved and updated.

SES is the spatial data integration system, in which the data from the different data sources can be integrated into the same data model and then streamed to the different clients. The data used in SES are the graphic vector data from the backend data sources to the frontend clients. Because of this, the data loss can be eliminated in the processes of transportation and conversion.

SES also provides the different types of clients for the different purposes. These types of clients can be Mobile Client, Web Client and Desktop Client. As long as the server has been configured, all these clients are able to access the server and conduct the same operations on the same data set. The configuration procedure is conducted only once, but for all types of clients.

SES is not GIS even through the map data might be used in the system as the background. SES doesn't handle the transformations of the spatial reference systems. SES doesn't handle the tasks of creating and presenting the maps even though it may use the map as the background.

SES is not CAD either. Even through SES entities and geometry shapes might be represented by 3D coordinates, SES doesn't provide the rich editing tools for the vector data like that the CAD programs do. SES just provides the minimum number of tools, which are just enough to handle the basic graphic needs for the enterprise models. But, SES provides the graphic programming frameworks, which gives the developers the chance to expand to the more powerful graphic editing tools for the solutions. The SES graphic API is powerful enough to write these graphic editing tools.

The architecture of SES is open, which make the system fully customizable. Solutions can be built on the top of the other solutions, while unnecessary solutions can also be eliminated. This ensures the system to always be in the lean and clean stage.

The present invention gives the definition, design and current implementation of SES.

### SUMMARY OF THE INVENTION

The present invention provides the new software system that solves the enterprise problems by using the spatial data. The architecture of this system is designed in three tiers—the data integration tier, the spatial server tier and the client tier. The data integration tier contains the different types of the data providers. It is the tier that brings the data into the system from the different data sources. The spatial server tier contains the spatial server. It is the tier that provides the services to the clients. The client tier contains the different types of clients which access the server to consume the services. These clients are used by the end users. The types of SES clients include Mobile Client, Desktop Client, Web Client and Admin Console. FIG. 1 shows the architecture of this system.

The system of the present invention can be expanded for the different enterprise solutions, which may cover the solutions in the different industries. FIG. 2 gives some example solutions that can be developed on this system. The system of the present invention provides the tools and methodologies to expand the current system for the enterprise solutions such as those listed in FIG. 2.

The system of the present invention also provides the implemented and prepackaged service modules. These modules can be executed on both server and client sides. The server executes the modules to provide the services to the clients. Clients execute these modules to access these services. FIG. 3 shows these service and service-access modules.

The system of the present invention has designed a scheme for the data to be fetched form different data sources and passed to the clients along with the metadata. Based on the metadata, the client can then display the integrated data on the client platforms in the spatial manner. FIG. 4 shows the flow of this data fetch.

The present invention also enables the data to be modified on the client, and then the modified data can be updated and stored to the different data source through the spatial server. FIG. 5 shows the flow of this procedure.

The system of the present invention also provides the detailed configuration procedures, through which the spatial server can be configured to the custom data model that fits to the business models of the enterprise organization. FIG. 6 shows the flow of this configuration procedure.

The system of the present invention provides the detailed GUI layout for each step of the configuration. These GUI layouts are the GUIs for the configurations of data sources, data models, resources, rendering models and user group. FIG. 7 through FIG. 11 shows these GUI layouts. These GUIs are packed on Admin Console, which is the client that handles the administration and configuration tasks.

Finally, the system of the present invention provides three types of client—Desktop Client, Mobile Client and Web Client. These clients are also packed or will be packed in the deployment package of the system. FIG. 12 and FIG. 13 show the GUI layout of two of these clients, Desktop and Mobile. The end results from the configuration procedure are displayed in these figures.

### BRIEF DESCRIPTION OF THE DRAWINGS

The present invention and the following detailed description of certain embodiments thereof may be understood by reference to the following figures:

FIG. 1 shows the three-tiered architecture of SES. It also depicts the key components in each tier.

FIG. 2 lists the potential solutions that can be developed on SES. The figure is just for the exemplary purpose. It would be impossible to draw the complete list of the solutions.

FIG. 3 shows the service components on the server and the service-access components on the clients. These modules are developed based on the granularity and functionality of the services.

FIG. 4 shows the flow chart of the procedure of how the data being passed from the different data sources to the frontend clients.

FIG. 5 shows the flow chart of the procedure of how the data have been modified on the client, passed to the backend server and eventually stored into the different data sources.

FIG. 6 shows the configuration procedure of SES for the data models of the business logics.

FIG. 7 shows the GUI details of the data source configuration. The data is brought into SES based on settings in this configuration.

FIG. 8 shows the GUI details for the data model configuration. These data models are the data models for the business logics.

FIG. 9 shows the GUI details for the rendering model configuration. The rendering model describes how the data are displayed and how the data objects behave on the clients.

FIG. 10 shows the GUI for the user group configuration. This procedure creates and configures the user profiles, the access region and the access rights for the users.

FIG. 11 shows the GUI for the resource editing tools, which enables the user to bring the resources such as symbols, images, styles, line patterns and fill patterns into the system for rendering.

FIG. 12 shows the GUI of the desktop client. The client shows the end result of the configured data model and rendering model in the graphic canvas.

FIG. 13 shows the GUI for the mobile client. The client shows the end result of the configured data model and rendering model in the graphic canvas.

### DETAIL DESCRIPTION

The following detailed description, which references and incorporates the drawings, describes and illustrates one or more exemplary embodiments of the invention. These embodiments, offered not to limit but only to exemplify and teach the invention, are shown and described in sufficient details to enable these skilled in the art to practice the invention. Thus, where appropriate to avoid obscuring the invention, the description may omit certain information known to those of skill in the art.

SES architecture is designed to meet the three major goals—the need for the enterprise solutions, the demand for modern computing technologies (cloud and mobile computing) and the requirement of the intuitive look-and-feel for the spatial enterprise data objects. In order to achieve these goals, SES architecture has been designed to meet the following requirements:
a. The client interfaces must be universal, which enables the developers to write code once and run it on the different platforms for all the clients of desktop computer, mobile device and web browser.
b. The client must be thin, which means the footprints of the runtime memory and the installation size must be small. Only the thin client can be deployed for the varieties of the platforms.
c. There must be an administration client, called Admin Console, which plays the configuration roles for Data Integration, Data Modeling, Rendering Modeling, Customization Modeling and User Group Management.
d. The architecture of the server and the clients must be open so that the server can serve the clients with either prebuilt or expanded services.
e. The prebuilt services, which run on the spatial server, handle the functions of Data Integration, Data Modeling, Rendering Modeling, Data Access, Customization and User Group Management.
f. The expanded services must be able to be developed for the particular enterprise solutions, such as the solutions of pipeline, electricity, environmental management, etc.
g. Through the custom data providers, the existing data source of the enterprise systems must be able to be adapted to the data models for the new solutions in SES, which requires the data providers must be customizable.

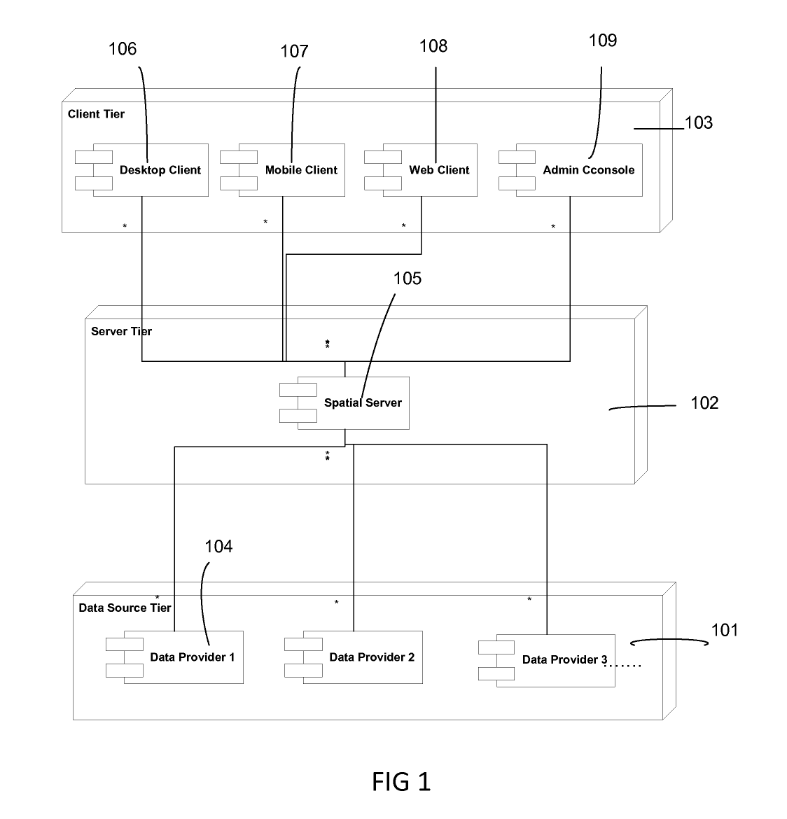

Given the above requirements, the architecture of SES has been designed in three tiers, as shown in FIG. 1. These three tiers are Data Source Tier (101), Server Tier (102) and Client Tier (103). Data Source Tier handles the functionalities of the data integration and the data access. Server Tier provides the common ground to run the different services. Client Tier requests and consumes the services from the server, and displays the results processed by the services.

Data Source Tier consists of the different data providers (104). Data providers can be either prebuilt or expanded as the plugins. As a packaged system, SES packs a set of the prebuilt data providers, which provide the connection channels to access the different types of the data sources. In addition, the programming API (Application Programming Interface) is also provided as the part of the deployment package of SES. Developers can use the API to write the special data providers to connect the special types of the data sources.

Server Tier is the tier where the actual server, Spatial Server (105) resides. Server serves the clients by providing the services. There are a set of services packed in the SES deployment package, which should be enough to get user to start to configure and browse the spatial data. Meanwhile, the new services can also be created or extended from the existing services. SES service API provides the necessary programming interface to achieve this. By making these services working together, SES can act as the powerful system to support the spatial enterprise solutions in the different industries.

Client Tier (103) consists of the different types of clients. These clients requests and consumes the services provided by the spatial server. Depending on the running platforms, the clients are provided as Desktop Client (106), Mobile Client (107), Web Client (108) and Admin Console (109). Desktop Client (106) is the client program running on the desktop or laptop machines. Mobile Client (107) is the client program running on the mobile devices such as the pocket PC and the smart phones. Web Client (108) is the client running on the Web browser. And Admin Console (109) is the administration program running on the desktop to setup and configure the services on the server.

The open-platform principal is enforced for the different clients. This means the developers can write the plugins for the platforms. And the universal API has been defined for the different platforms, which enables the developers run the same code for different platforms.

In FIG. 1, it is noticed that all the clients are accessing to the same server. In SES, once the server has been setup and configured, all the clients can access to the server and use the configured services on all supported platforms. And all the clients will get the same result by requesting the same services with the same parameters. Doing this can reduce the cost of the maintenance of the enterprise systems and simplify the process of the deployment for the enterprise solutions.

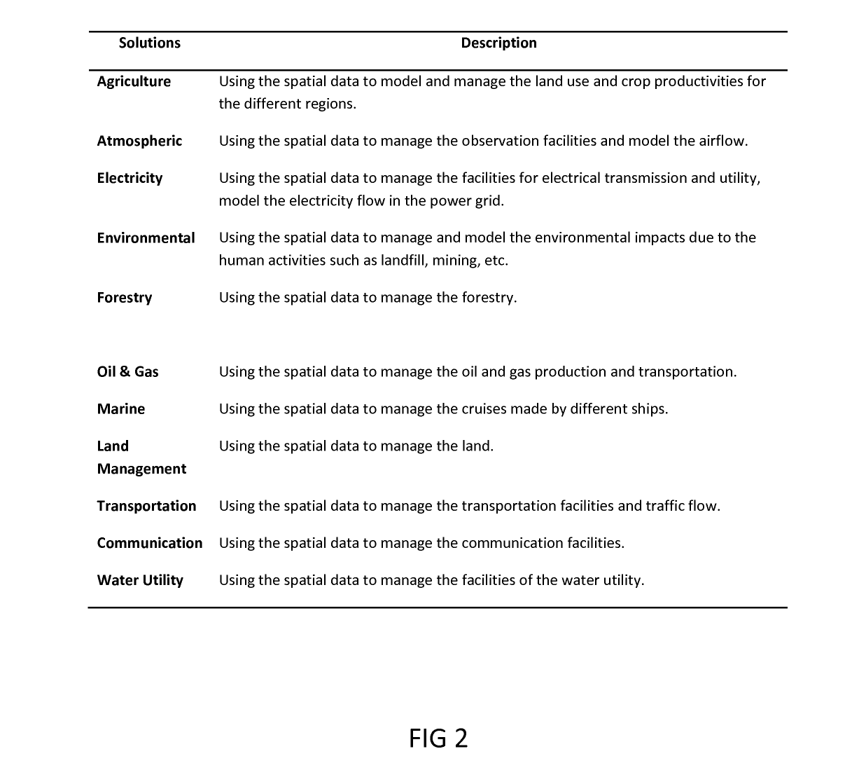

SES is invented for the enterprise solutions. And the spatial data will make the system easier to use. FIG. 2 lists some of the example solutions that can be provided on SES. Based on the detail requirements, the custom services can be developed on SES to implement these solutions. The intention of SES is to provide the universal platform to support these solutions, while the development efforts and the maintenance costs are reduced to the minimum.

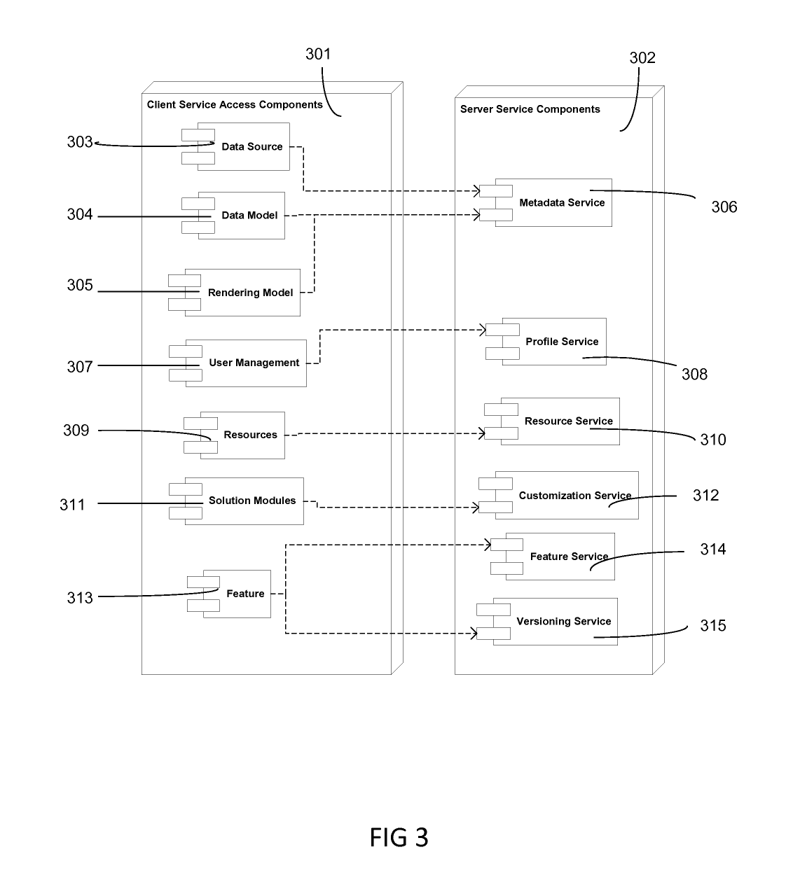

The spatial server provides the services to the clients, and the clients consume the services on the server. Clients access the services on the spatial server by the service-access components. FIG. 3 shows the prebuilt service-access components (301) on the client and the prebuilt service components (302) on the server. The service-access components of the clients are the components to request and consume the server services. And the service components of the server are the components to provide the services to the clients.

Services are provided by the spatial server and consumed by the clients. In SES, the solutions are provided by the integration of the different service models. The following are the service models defined in the SES to provide the solutions in different aspects (as shown in FIG. 3):
a. Metadata Service (306) provides the functions of defining, configuring and creating the metadata that can be supported by the system;
b. Profile Service (308) provides the functions of defining, configuring and creating the profiles of the users who need to access the system;
c. Feature Service (314) provides the functions of fetching, adding, deleting and changing the feature data in the different data sources;
d. Resource Service (310) provides the functions of defining, configuring and creating the resources such as the images and the symbols for the system to display;
e. Version Service (315) provides the functions of defining, configuring, creating and enforcing the modification policies of the data through the system;
f. Customization Service (312) provides the functions to expand the existing services or create the new services;

The client requests and consumes the services through the service access modules. In SES, the following service-access modules are defined (as shown in FIG. 3):
a. The components, Data Source (303), Data Model (304) and Rendering Model (305) are designed to access and consume the metadata service (306) provided by the server.
b. The component, User Management (307) is designed to access and consume the profile service (308) provided by the server.
c. The component, Resources (309) is designed to access and consume the resource service (310) provided by the server.
d. The component, Solution Modules (311) is designed to access and consume the customization services (312) provided by the server.
e. The component, Feature (313) is designed to access and consume the feature service (314) and versioning service (315) provided by the server.

Data model is a collection of data objects that are defined to be the participants for the enterprise solutions. The data objects in data model are usually the virtual representations of the real business objects. Feature is the virtual representation of the spatial object of this world. It is the commonly-used concept in GIS. In SES, feature is adopted as the object instance of the data model. Since the data model in SES is the collection of the entities of the actual business logics, the features in the data model represent the spatial entities as the participants of the business logics.

The granularity of features may vary depending on the scope of the data model. For instance, in one case, if the data model is the map model to provide the geographic map service, the features might be countries, states, counties or streets. In another case, if the data model is for the enterprise transportation system to handle the logistic business logics, the features might be vehicles, drivers, driving routes, truck stops or warehouses. Feature can be anything in this world as long as it's properly defined for the data model of the business logic.

The spatial data in SES can be categorized in two basic types, the feature data and the metadata. Both types of data are used to represent the features. The feature data is the data to represent the particular feature instance. For instance, a particular street or a particular landmark can be the instances of the feature data. Defined by the schema definitions, feature data are stored in the data sources in the forms of the attributes. The types of attributes can be the geometric types such as point, polyline and polygon as well as other general types such as strings, integers and floating point numbers.

In SES, entity, which is the commonly-used concept in CAD systems, is adopted for the displayable objects. The features are displayed on the client as the entities. An entity is the displaying object on the clients to represent a feature. The entities are created from the feature data and metadata. They are the objects that can be directly passed to the SES rendering engine for rendering. Feature data defines the data attributes of the entity, and the metadata defines the rendering and relationship properties of the entity.

Feature data are stored in the data source, grouped into the data models and displayed on the client as the entities. To store in the data source, there must be the different data tables in the data sources. To group features into the data models, there must be the different feature types in the data models. And to render features on the clients, there must be the rendering layers in the rendering models. Metadata is the data object to describe the behavior of the feature data in terms of data storage, data model and rendering model. In SES, metadata gives the descriptions of where the feature data come from, how the feature data are stored and how the feature data are displayed. In more detail, the types of the metadata in SES include:
a. The definitions of the data sources;
b. The schema definitions of the data table inside the data source;
c. The definitions of the data models;
d. The definitions of the feature types in the data model;
e. The definitions of the rendering models;
f. The definitions of the different layers in the rendering model.

In above list, the data source contains the data tables. The data model contains the feature types. And the rendering model contains the rendering layers.

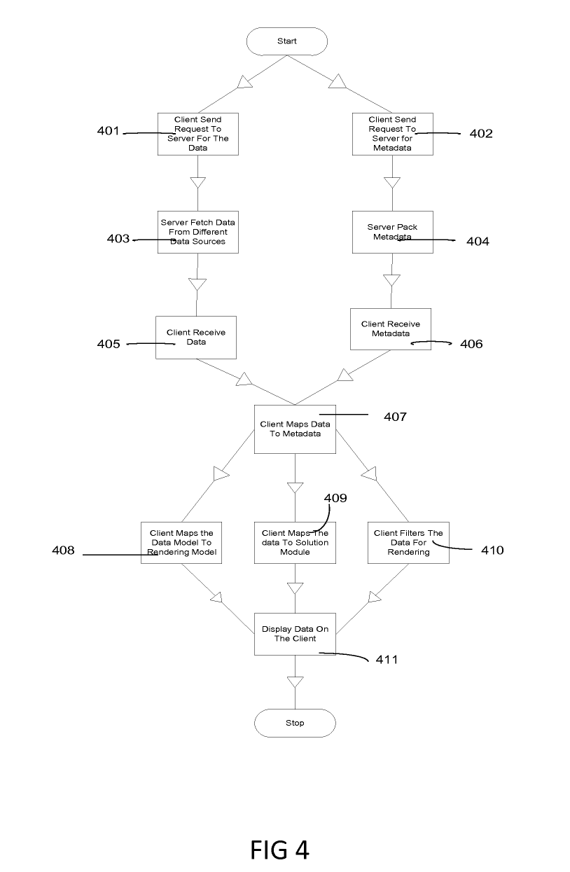

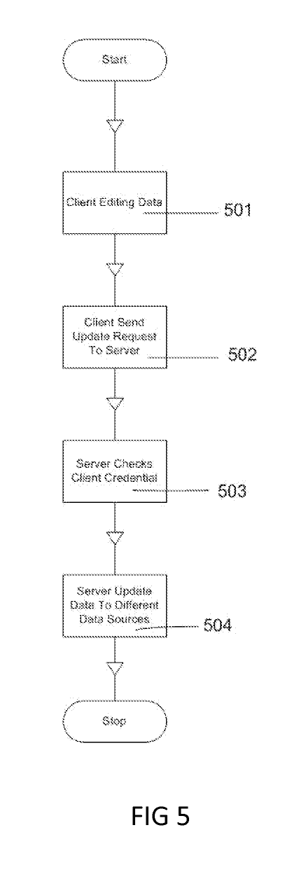

The features need to be converted to the entities in order to be displayed on the client. Meanwhile, the modified entities need to be converted back to the features in order to be stored to the data sources. This is the bi-directional conversion procedure. The present invention has designed and implemented this procedure, which is depicted in FIG. 4 and FIG. 5.

FIG. 4 and FIG. 5 show the SES data flow of how the data are passed from the backend data sources to the frontend client. In one direction, the feature data are retrieved from different data source and displayed in the clients. In the other direction, the feature data are modified in the clients and saved to the different data sources. In both directions, the data must be passed through the spatial server.

FIG. 4 shows the flow of the data-retrieving direction of the workflow. In (401), the client sends the data request to the server. In (403), after the server receives the request, it fetches the data from different data sources. At the same time, the client also sends the second request to the server for the metadata (402). Server then receives the request from the client, packs the metadata (404) and sends it to the client. In (405) and (406), the client receives the feature data and the metadata, and then in (407), the rendering engine on the client maps the feature data to the metadata. This data mapping process (407) is conducted in three sub-processes—mapping the data to rendering model (408), mapping the data to the solution modules (409) and filtering the data for the rendering (410). Finally, in (411), the entities are created and displayed on the client.

While the feature data can be retrieved from the different data sources as shown in FIG. 4, they can also be updated to the different data sources from the clients. FIG. 5 shows this data flow. In (501), the user edits the data by using the data editing tools on the client. In (502), the client sends the update request to server along with the modified feature data. The spatial server then checks the user's credential (503). Then, in (504), the server updates the date to different data sources.

The feature data must be displayed on the clients as described by the metadata. To achieve this, metadata plays the important roles in SES. Metadata determines the appearances of the data objects to be represented on the clients. Metadata also describes how the spatial objects should behave under the different circumstances. How to create and configure the metadata is vital on designing SES. The present invention provides the detailed procedure of how the metadata are created and configured. The functions of this configuration procedure are packed in Admin Console (109), which is one type of the clients that is deployed in SES. User can use Admin Console to achieve these configuration goals.

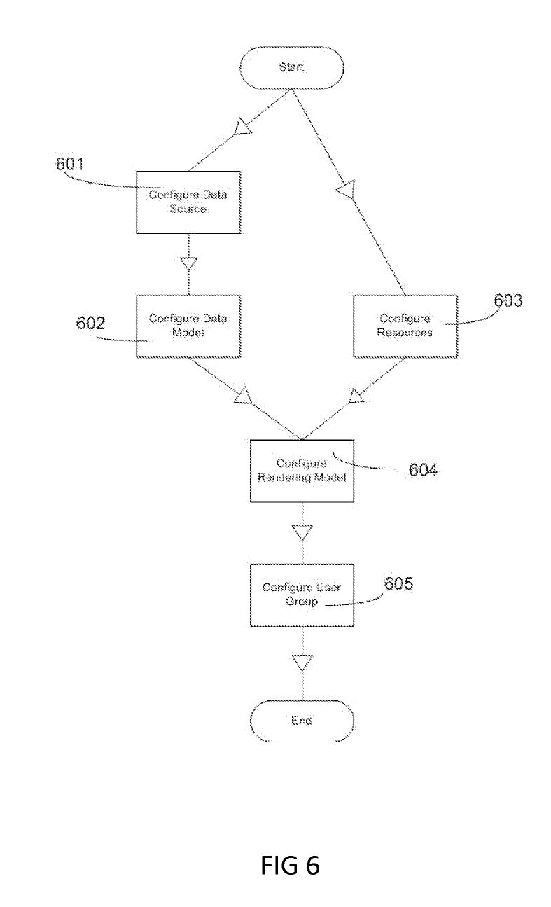

FIG. 6 shows the overall configuration procedure. The configuration procedure includes the following steps to configure the different types of the metadata:
a. Data Source (601) configuration is the procedure to configure the data sources and the data tables of the data sources.
b. Data Model (602) configuration is the procedure to configure the data models and the feature types in the data models.
c. Resources (603) configuration is the procedure to configure the resources such as image and symbols that can be used as the displaying resources.
d. Rendering Model (604) configuration is the procedure to configure the rendering models and the rendering layers in the rendering models.
e. User Group (605) configuration is the procedure to configure the user and user group, and the permissions for the users to access the data models and the rendering models.

The data source configuration (601) is the procedure to create, register and import the data sources. In more detail, it is the procedure to create the definitions of the data sources and the data schemas of the data tables in these data sources. It is also the procedure to ensure that all the necessary parameters are registered in the system so that the server can just these parameters to establish the connection for retrieving and updating the data in the data sources.

The data model configuration (602) is the procedure to configure the data model. Usually, the data model consists of the feature types, which represent the participating object types for the business logic. These feature types are the definitions of the acting objects to perform the activities in the business logics for the enterprise organization.

The resource configuration (603) is the procedure to configure the resources that could be used by the rendering model. The resources are the graphic objects such as symbols, images, line patterns and fill patterns.

The rendering model configuration (604) is the procedure to configure the styles of the data model. The rendering model consists of the rendering layers. The styles of the rendering layers must be configured in order to be displayed. And the definitions of these rendering layers will be passed to the client to render the different feature objects.

User group configuration (605) is the procedure to create and register the user and user group into the system. It also sets the data access rights for the user or user group. The data access rights are the rights given to the user or user group to permit them for the access of the data layer or data region.

FIG. 6 shows the entire configuration procedures as the flow chart, which is the preferred order to conduct the different types of configurations. In fact, these steps do not depend on each other. Each step can be conducted independently, which enables the different developers in different roles working independently on their part.

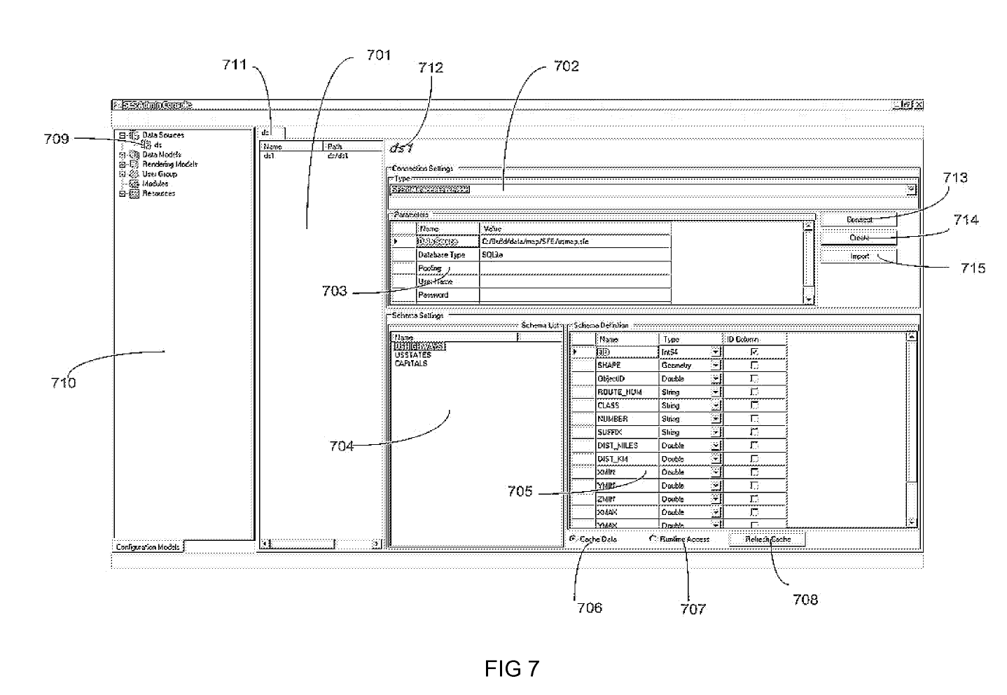

FIG. 7 shows the GUI layout for the data source configuration. In SES, the data sources are grouped in the data source groups. One data source group can contain one or more child data source groups. The data source group is just the virtual container to categorize the different data sources.

The data source group contains the data sources. The data source is the source that physically stores the feature data. Each data source contains one or more data tables. Just like the table in the relational database, a data table contains the rows and columns to store the data. The schema defines the data type and the integrity rules for the rows and columns in the data table. SES adopts the schema definitions to define the data tables in data source. In SES, these schema definitions and other properties of the data tables are described in the data source metadata. In detail, to ensure the data sources can be accessed by SES server, the following metadata of the data source are configured and stored in the metadata database:
a. Data source name;
b. Data source type;
c. Connection parameters;
d. Data schema references;
e. The schema definition for each table in the data source.

The data source configuration has been designed as the graphic user interface (GUI) in Admin Console. FIG. 7 shows the GUI layout for the data source configuration procedure (601). The tree control (710) contains the root nodes for all types of metadata including data source, data model, rendering model, user group, modules and resources. The data source group, which is represented by the node under the Data Sources node, is the collection of the data sources. One data source group can contains one or more child data source group and child data sources. The data source group can be created under the root node of Data Source by using the regular tree control operation. As shown in FIG. 7, one data source group (709) named “ds” has been created under the node of Data Source. When the data source group (709) is selected, a tab (711) is added on the right panel to display the child data sources for the selected data source group (709).

The child data sources in the data source group are displayed in a list box (701). The list box (701) is used to add, remove and rename the data source under the selected data source group. When the item is selected in this list box, the panel on the right will be refreshed to display the properties of the selected data source. In FIG. 7, the label control (712) indicates the name of the selected data source.

After the data source group and the data source haven been selected, it's the time to configure the properties of the data source. In FIG. 7, the dropdown box (702) displays the different types of the available data sources that can be used in SES. Each item in this dropdown box (702) represents one type of the data provider (104). When the item for the dropdown box has been selected, the parameter table (703) will be refreshed to display the connection parameters for the particular type of data provider. User can set the values in this table. After the parameters haven entered, user has three options to move forward—to connect to the data source, to create the data source, or to import the data source. The three buttons, Connect (713), Create (714) and Import (715) are designed for these three options. Connect option registers the existing data source, Create option creates the new data source, and Import option creates a new data source and copies the schemas of the selected data source into this newly created data source. For the import option, the data from the selected data source will also be imported into the newly created data source.

The list box for the schema settings (704) shows the names of the data tables in the data source that has been connected. By selecting the item of the schema list box (704), the table (705) on the right side will be refreshed to display the schema definitions of the selected data table.

The schema list box (704) allows the user to add the new data tables, rename and remove the old tables. Removing the table will only remove the metadata definition stored in SES. The original storage table will be remained. The column definition table (705) allows user to add, delete and modify the column definitions of the selected data table. These operations ensure that SES only uses the required data for the data model; other data will keep untouched and stored in the original data source.

SES also supports the server-side data caching. Using the radio buttons, Cache Data (706) and Runtime Access (707), can achieve this. If Cache Data (706) is checked, the data retrieved from the selected data table will be cached on the SES server for the future access. If Runtime Access (707) is checked, no data for the data table will be cached. For the runtime access option, the server will directly access the data source for the selected table to feed the data for the data model. Refresh Cache button (708) will refresh the cache with the new set of data from the original data source. The data caching option is applied to each table.

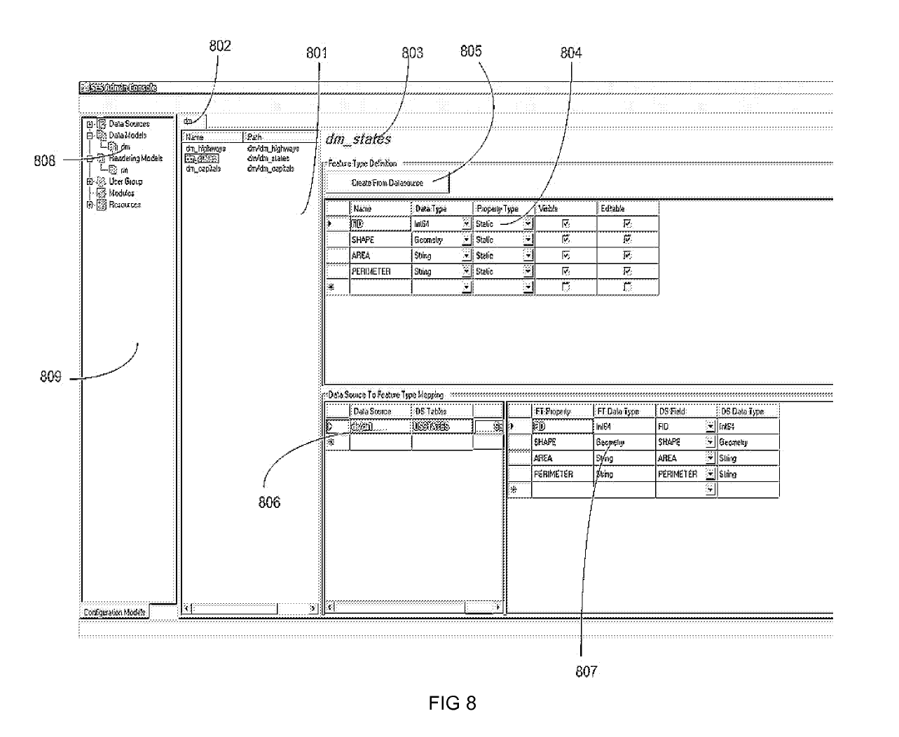

Data source configuration ensures that SES can access the different data sources and retrieve data from these data sources. But in order to use the data to model business logics, the data from different data sources must be passed to the business model derived for the business logic. Since the business model is achieved through the data model, the procedure for creating and configuring the data mode is necessary. FIG. 8 shows the GUI layout for this procedure.

Data model is the object model that represents the actual business logics. The objects in the data model are also called the features, which represent the business entities of the daily business logics in the enterprise organization. In order to model the business entities by using the original data sources, SES data model must have the following information configured:
a. Data model name;
b. Feature types in this data model;
c. Attributes for each feature type;
d. Data source table reference from which the data can be retrieved and stored;
e. Mapping relationship between feature type attributes and data table schema.

FIG. 8 depicts the GUI layout for this configuration procedure. Similar to the tree control (710) in FIG. 7, the tree control (809) is the starting point for this data model configuration. Under the Data Model node in this tree control (809), either data model or data model group can be added, deleted and renamed. The data model group is the group that contains one or multiple data models. One data model can contain one or more feature types. After the data model node (808) has been selected in the tree control (809), a new tab (802) will be displayed on the right. The list box (801) is used to configure the feature types. This list box allows user to add, remove and rename the feature types. If the feature type is selected in this list box, the panel on the right will be refreshed to display the properties of the selected feature type. The top label (803) shows the name of the selected feature type.

The table in the middle (804) is the table for the feature type definition, which allows user to add, delete and modify the attributes of the feature type. There are two ways to generate the attributes of the feature type. One, user can directly add the attributes in the table (804) by using the regular table editing functions. Two, user can create the feature type definition from the existing data table of the data source that has already been configured in FIG. 7. In this case, the attributes of the data table will be the same as the attributes of the feature type. The button, CreateFromDatasource (805) is the button for this purpose. After the attributes of the feature type have been created, user can still edit the table until it becomes satisfactory.

In SES, Feature Service is the service to handle the tasks of the data access. On the client side, the service access module issues the data query by specifying which the feature type to be retrieved. Feature service on the server accepts the queries by the feature type and then uses the mapping relationship to get the data from the different data sources. This mapping relationship is the mapping between the feature type and the tables in the data sources. This mapping procedure must be executed at runtime but the relationship must be configured and stored in the system before the runtime execution. In FIG. 8, the two tables (806 and 807) are for this purpose. The data source mapping table (806) defines the data table of the data source to be mapped. In this table (806), the data tables from different data sources can be selected. By selecting the row in the mapping table (806), the table (807) on the right will be refreshed. The table on the right (807) is the attribute mapping table. It maps the data columns of the data source table to the attributes of the feature type. This table only allows the delete operation because it only needs the delete operation to filter out the fields in the data table that are not required to be mapped.

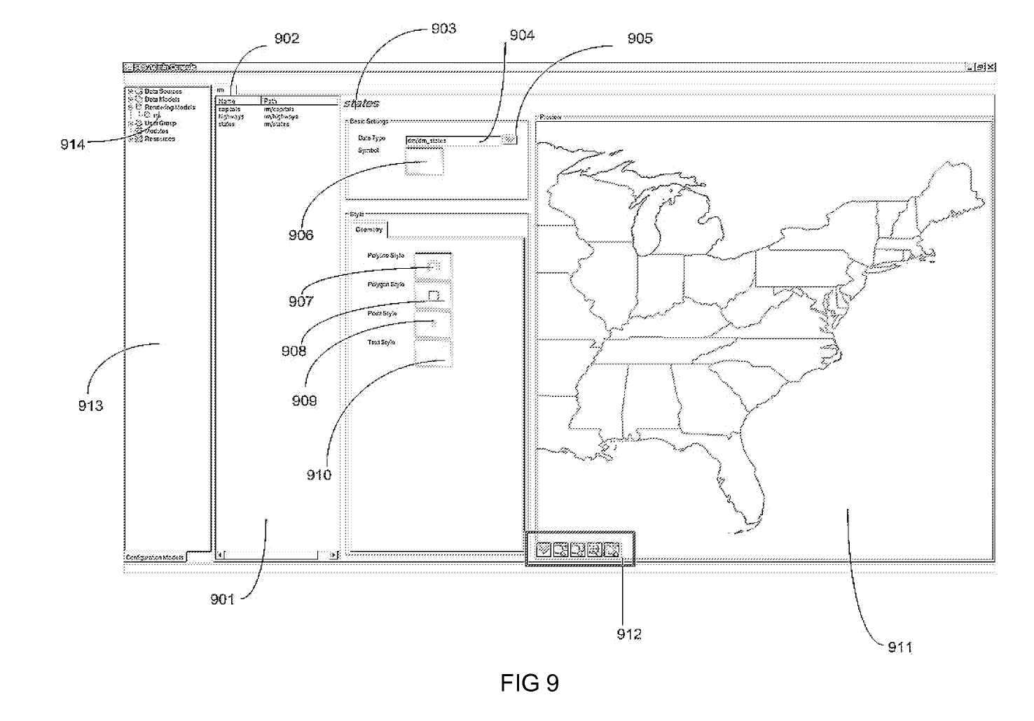

Data model defines the properties of the features and specifies where the data come from to form the features. But, the features must be displayed graphically on the client. For this purpose, the rendering model plays the role. FIG. 9 depicts the configuration procedure for the rendering model. Rendering model is the model to describe how the data model to be rendered. It's the metadata to guide the rendering engine on the client for rendering the features. A rendering model contains one or multiple rendering layers. The rendering layers define the rendering properties of the feature type. In SES, one feature type is associated with one rendering layer.

The rendering model configuration is the procedure of creating and configuring the following contents:
a. Rendering model name;
b. Rendering layers in the rendering model;
c. Feature type that each layer represents;
d. Symbol that the layer needs to be shown as the icon;
e. Geometry styles, which include line style, polygon style, point style and text style.

The configuration for the rendering model is also designed as GUI. FIG. 9 shows the GUI layout for the procedure of the rendering model configuration (604). Similar to the tree control (809) in data model configuration, the tree control (913) is the control to host all the configuration objects. By selecting one of the rendering models (914), a new tab (902) will be added on the right side. The list box (901) displays the rendering layers in the selected rendering model. This list box enables user to add, delete and rename the rendering layers (901).

If one of the rendering layers has been selected in the list box (901), the panel on the right side will be refreshed to display the properties of this layer. The label control (903) shows the name of the selected rendering layer.

The text box (904) is the control to enter the feature type to be represented by the selected layer. User has two options to enter the feature type in this text box. One, just type the path of the feature type in the data model configured in list box (801) in FIG. 8. Two, press the button (905) and a dialog box will be populated (not shown in figure). In this dialog box, user can select the feature type. Symbol control (905) is the control to configure the symbol for the rendering layer. By clicking this control, a dialog box will be populated to allow user to select the symbol for the layer.

Geometry styles are the important properties for the rendering layers. SES allows one layer contains multiple geometry types. To achieve this, SES provides the GUI to configure the styles for multiple types of geometry. The controls of Polyline Style (907), Polygon Style (908), Point Style (909) and Text Style (910) are provided for this purpose. By clicking these controls, the dialog box will be populated to allow user to configure the styles.

The preview control (911) displays the results for the configuration. Inside the preview control (911), the navigation buttons (912) allows user to browse the data for any improper settings for the adjustment. These navigation buttons include the typical graphic navigation operations such as Select, Zoom In/Out, Zoom Window, Zoom Fit and Pan.

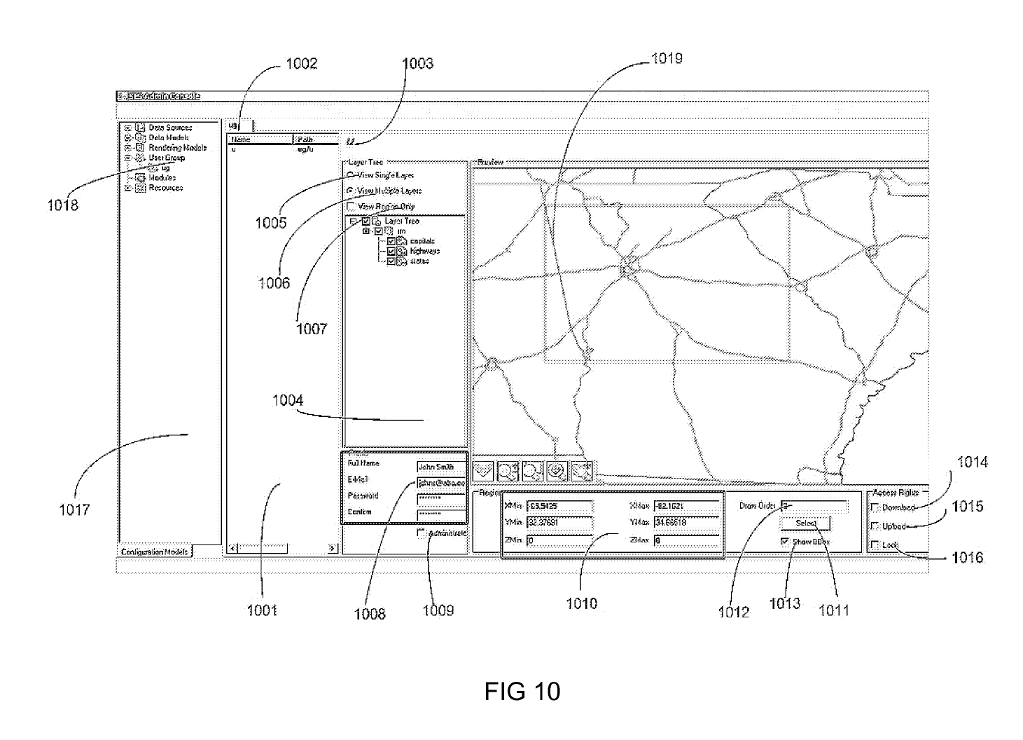

After rendering model has been configured, user must have the way to access the system to view and modify the data of the data model. In order for user to access the system, a set of access rules must be enforced. For this purpose, the configuration procedure of the user group has been designed and implemented. FIG. 10 shows the GUI layout for the configuration of user and user groups.

There are the different roles of users in the enterprise organizations. Some users need to manage the user groups. Some users need to update and lock the data. Some users may only need to download the data for viewing. User group configuration is actually the user management procedure to define the roles of each user and user group.

The configuration of user group includes configuring the following contents:
a. User group;
b. Users in the user group;
c. The rendering layers that need to be assigned to the user;
d. The draw order for each layer that indicate the order to display;
e. The region of the data that allows the user to access;
f. User profiles, including user name, login id, password and email;
g. Access rights for downloading, uploading and locking;
h. Administrator privilege.

FIG. 10 is the GUI layout for the use and user group configuration. User group (1018) can be added, deleted and renamed in the tree control (1017). Selecting the user group (1018) will refresh the new tab (1002) on the right side. This tab panel contains the parameters that need to be configured for this selected user group. The list control (1001) lists the users in this group. By selecting the specific user in this list, the panel on the right side will be refreshed. The label control (1003) on the top shows the name of the user that is currently selected.

The tree control (1004) displays the rendering models that have been assigned to this user. These rendering models have been configured in FIG. 9. The rendering models in this tree control can be added, deleted and modified. The preview panel (1019) displays the rendering layers selected in the tree control (1004) with the configured parameters.

The two radio buttons, View Single Layer (1005) and View Multiple Layers (1006) are the options to control the view panel (1019). When View Single Layer (1005) is checked, the preview panel (1019) will only display the single layer selected in the rendering layer tree (1004). When View Multiple Layers (1005) is checked, the check boxes will be added to each node in the tree control (1004). The preview panel (1019) will display the multiple layers that have been selected. The display order of the multiple layers will be controlled by the number specified in the Draw Order textbox (1011).

The user profile data is configured in a group of text boxes (1008). Administrator check box (1009) sets the administrator privilege for this user. With the administrator privilege, the user can modify the definition of other users in the same group and the child groups under it if there is any.

The user access region is also configured by a group of textboxes (1010). User can have two ways to set these values, either directly entering the values to these text boxes (1010) or pressing the select button (1012). After the select button (1012) has been pressed, user will be allowed to draw a rectangle in the preview panel (1019). The values of the rectangle will be automatically entered into the region text boxes (1010). The check box, Show BBox (1013) controls whether or not the region bounding box is displayed in the preview panel.

The check boxes, Download (1014), Upload (1015) and Lock (1016) controls the access rights of the selected user for the selected layer in the layer tree (1004). If the check box, Download (1014) is checked, the user can download the data of this layer. If the check box, Upload (1015) is checked, the user can upload the data to the server. If the check box, Lock (1016) is checked, the user can lock the layer to prevent the data layer from being overwritten.

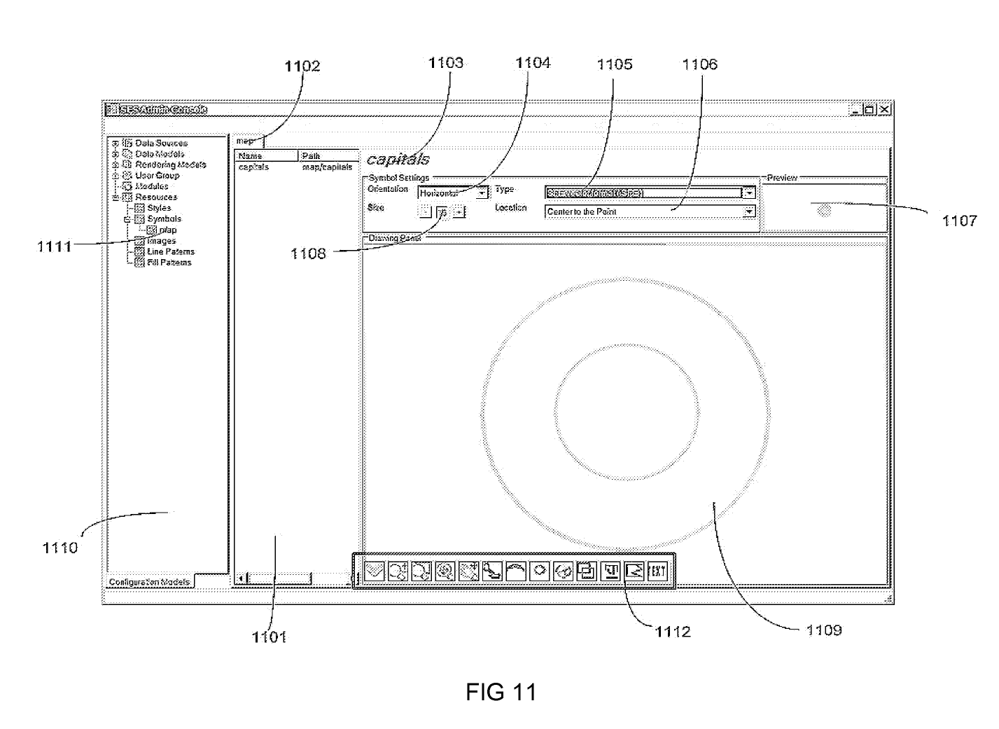

Geometry styles in the rendering model need the resources to support. Point style needs to be supported by symbols, line style needs to be supported by line patterns, and polygon style needs to be supported by fill patterns. For this purpose, the resources need to be configured for the rendering models. FIG. 11 shows how the resources can be configured.

Resources can be styles, symbols, images, line patterns and fill patterns. For simplicity, only symbol configuration procedure is described here. The configuration of other types of resources will be similar to the symbol configuration.

The configuration of symbol includes the configuration of the following contents:
a. Symbol group;
b. Symbols in the symbol group;
c. Symbol name, type, size, orientation and location;
d. Symbol drawing.

FIG. 11 shows the GUI to configure the symbols, which is one of the resource types supported by SES. The symbol groups (1111) can be added, deleted or renamed under the tree control (1110). After the symbol group (1111) has been added and selected, the tab (1102) on the right side will be refreshed for the symbols in this group. The list control (1101) displays the symbols in the selected symbol group. Selecting the item in the list control (1101) will refresh the right panel. The label (1103) on the top shows the name of the symbol that has been selected. The dropdown box, Orientation (1104) allows user to select the orientation of the symbol. It has three options, Horizontal, Vertical and Along the Line. The dropdown box, Type (1104) allows user to bring different types of resources as the symbol in SES. The types of the resources can be the vector and raster formats data that are supported by SES. The dropdown box, Location (1106) allows user to select what location this symbol should display. It has three options, Center of the Point, Center of the Line and Center of the Polygon.

The preview panel (1107) displays the symbol for the preview purpose. The text box, Size (1108) allows user to adjust the size of the symbol to be displayed on the client. The size of the symbol is set by the pixel size. When it's displayed on the client, it will be exactly the same as shown on the preview panel (1107).

The drawing panel (1109) is the panel that allows the user to edit the symbol. It provides a set of tools (1112) to ensure the symbol can be edited for the user's satisfaction.

After all the configurations have been completed, the features need to be displayed and modified in the clients. SES provides three types of clients to render the features—Desktop Client, Mobile Client and Web Browser Client.

Feature displaying and editing for different clients are the same in SES. No matter what kind of client the user is running, the appearances of the features and the workflows of manipulating the features are the same. No extra work needs to be done to bring the feature to different clients.

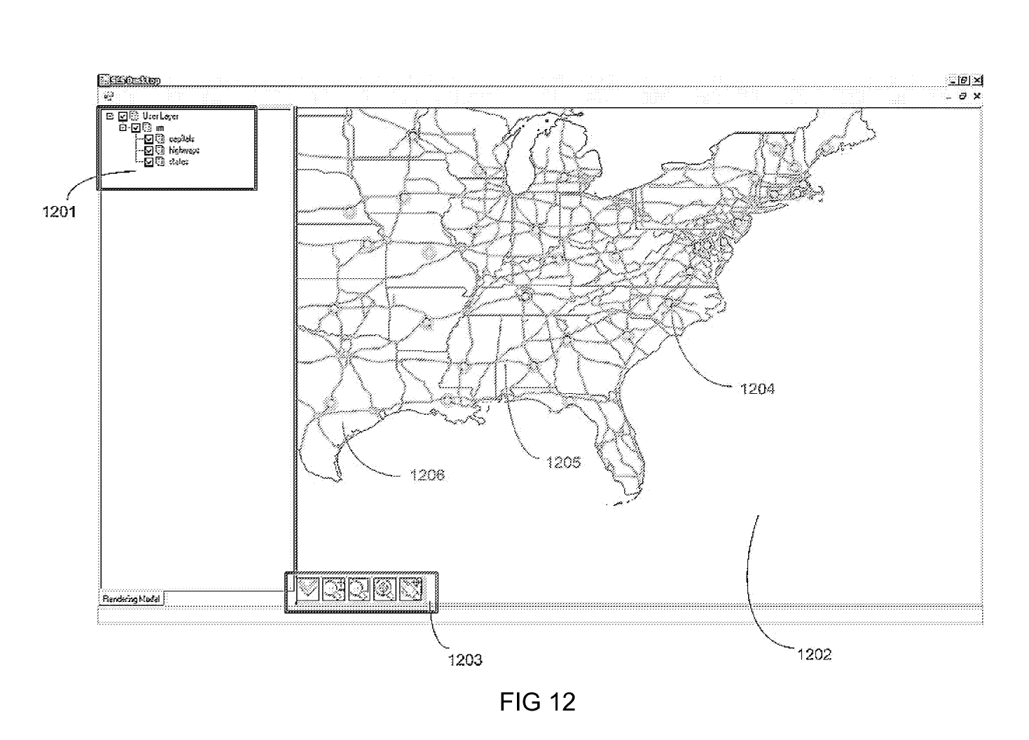

FIG. 12 shows the features displayed on the desktop client. After the user login, the tree control (1201) will show the rendering layers that have been assigned to this user. These layers have been configured as shown in the tree control (1001) in FIG. 10. As part of the client functions, the data navigation panel (1202) is provided on the client as shown in FIG. 12. The navigation tools (1203) are provided in this navigation panel to allow user to navigate the data.

Inside the data navigation panel (1202), the data is displayed as what has been configured. The styles of point (1204), line (1205) and polygon (1206) have been applied to the data models as configured in FIG. 9. For this particular case in FIG. 12, (1204) displays the states capitals, (1205) displays the high ways, and (1206) displays the states.

The symbol for the point style (1204) was created in FIG. 11. And the login process (running behind scene) enforces the user's credential configured by the user configuration procedure.

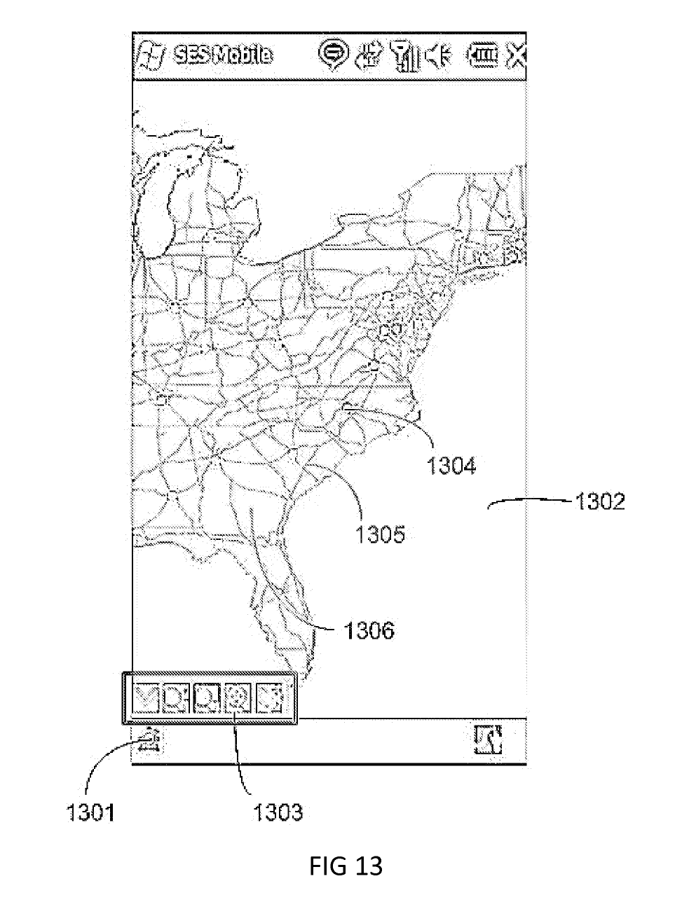

FIG. 13 shows the feature displayed on the mobile device client. This is similar to the desktop client depicted in FIG. 12. After the user login, the user layer tree will also be displayed just as described in FIG. 12 for the tree control (1201). Due to the limitation of the displaying space on the mobile decide, a button (1301) is provided to show/hide the user layer control. As part of the client functions, the data navigation panel (1302) is also provided on the mobile client. Inside the data navigation panel (1302), the navigation tools (1303) are provided. In FIG. 13, the data is displayed as configured (1304, 1305 and 1306) in the data navigation panel (1302). For this particular case, (1304) displays the states capitals, (1305) displays the high ways, and (1306) displays the states.

What is claimed is:

1. A spatial enterprise system, which uses the spatial data to provide the enterprise solutions, comprises
a. A data source tier including a variety of data providers which are developed according to the defined interfaces in order to establish the connection channels to the original data sources;
b. A server tier including the spatial server which provides the services to a variety of clients;
c. A client tier including a variety of clients which can access the server to consume the services.

2. The data source tier of claim 1a is the data source integrator for the different data sources.

3. The client tier of claim 1c comprises a variety of clients, including:
a. A desktop client comprises a client executable program that runs on the desktop computers to request and consume the services provided by the server of claim 1b;
b. A mobile client comprises a client executable program that runs on the mobile devices such as smart phones to request and consume the services provided by the server of claim 1b;
c. A admin console comprises a client executable program to configure the services and the data models of the business logics provided by the spatial server of claim 1b;
d. A web client comprises a client executable program running inside the web browsers to request and consume the services provided by the server of claim 1b.

4. The services of claim 1b comprises:
a. A metadata service defines the data types and describes the behaviors of the data objects;
b. A profile service comprises the operations managing, configuring and enforcing the security policies for the users using the system of claim 1;
c. A resource service configuring, storing and accessing the resources such as symbols and images;
d. A customization service comprises the operations installing and accessing the custom modules for the system of claim 1;
e. A feature service comprises the processing operations for retrieving and updating the feature data of the data sources of claim 2;
f. A version service comprises the operations configuring and enforcing the updating policies of the feature data.

5. The client tier of claim 1c comprises multiple software modules to access the server and consume the services provided by server, including:
a. Data source module comprises the methods assessing the server and consuming the data source part of the metadata services of claim 4a;
b. Data model module comprises the methods accessing the server and consuming the data model part of the metadata service of claim 4a;
c. Rendering model module comprises the methods accessing the server and consuming the rendering part of the metadata service of claim 4a;
d. User management module comprises the methods accessing the server and consuming the profile service of claim 4b;
e. Resources module comprises the methods accessing the server and consuming the resource service of claim 4c;
f. Solution modules comprises the methods accessing the server and consuming the customizations services of claim 4d;
g. Feature module comprises the methods accessing the server and consuming the feature services and versioning service of claim 4e.

6. A computer-implemented procedure to fetch the feature data from the client tier of claim 1c through the spatial server of claim 1b, including:
a. Sending requests for feature data and metadata from the client tier of claim 1c;
b. Receiving the requests for feature data and metadata on the spatial server of claim 1b;
c. Fetching the feature data using the data providers of claim 1a;
d. Packing the metadata on the spatial server of claim 1b;
e. Sending the feature data and metadata on the spatial server of claim 1b;
f. Receiving the feature data and metadata on the client tier of claim 1c;
g. Mapping the metadata to feature data on the client tier of claim 1c;
h. Displaying the feature data as configured on the client tier of claim 1c.

7. The method of claim 6g, wherein mapping the metadata to feature data comprises:
a. Mapping the data model to the rendering model;
b. Mapping the data model to the solution module;
c. Filtering the data for the rendering at the runtime.

8. A computer-implemented procedure updating the feature data from the client tier of claim 1c through the spatial server of claim 1b, including:
a. Editing the feature data on the client tier of claim 1c;
b. Sending the updating request to the spatial server of claim 1b on the client tier of claim 1c;
c. Checking the user credential on the spatial server of claim 1b;
d. Updating the data to the different data sources of claim 1a through the data providers of claim 1a on the spatial server of claim 1b.

9. A computer-implemented procedure managing and configuring the system of claim 1, including:
a. Configuring the data sources of claim 1a;
b. Configuring the data models to fit the business models and mapping the data models to the data sources;
c. Configuring the resources;
d. Configuring the rendering models and mapping the rendering model to the data model;
e. Configuring the user group and assigning the rendering models to the users.

10. The method of claim 9, wherein configuring the data sources of claim 1a comprises:
a. Connecting the data sources;
b. Creating the data sources;
c. Importing the data definitions and the data contents;
d. Deleting the data definitions of the data sources;
e. Storing the data definitions of the data sources.

11. The method of claim 9, wherein configuring the data model to fit the business models and mapping the data models to data sources comprises:
a. Creating the feature types;
b. Modify the feature types;
c. Deleting the feature types;
d. Mapping the feature types to the data tables of the data sources;
e. Mapping the attributes of the feature types to the columns of the data tables.

12. The method of claim 9, wherein configuring the resources comprises:
a. Editing the resources;
b. Modifying the resources;
c. Deleting the resources;
d. Storing the resources.

13. The method of claim 9, wherein configuring the rendering models comprises:
a. Creating and deleting the rendering layers;
b. Configuring the geometry styles of the rendering layers;
c. Configuring the symbols of the rendering layers;
d. Mapping the feature types in the data model to the rendering layer;
e. Previewing the rendering layers.

14. The method of claim 9, wherein configuring the user group comprises:
a. Adding and deleting the user group;
b. Adding, deleting and modifying the users in the user group;
c. Selecting the rendering model for the users in the user group;
d. Setting up the user names, the passwords and the email addresses for the users in the user group;
e. Setting up the access region for the users in the user group;
f. Setting up the access right for the users in the user group;
g. Setting up the administrator right for the users in the user group.

15. The desktop client of claim 3a comprises the frontend GUI for accessing, navigating and modifying the data models of business logics, including:
a. A tree control displaying the rendering models;
b. A graphic displaying panel to display the data based on the configured data model;
c. A set of tools to navigate and edit the graphic feature data.

16. The mobile client of claim 3b comprises the frontend GUI for accessing, navigating and modifying the data models of business logics on the mobile devices, including:
a. A tree control displaying the rendering models;
b. A graphic displaying panel to display the data based on the configured data model;
c. A set of tools to navigate and edit the graphic feature data.

17. The web client of claim 3b comprises the frontend GUI for accessing, navigating and modifying the data models of business logics inside the web browsers, including:
a. A tree control displaying the rendering models;
b. A graphic displaying panel to display the data based on the configured data model;
c. A set of tools to navigate and edit the graphic feature data.
